(19) United States
(12) Patent Application Publication
(10) Pub. No.: US 2011/0143115 A1
(43) Pub. Date: Jun. 16, 2011

(54) INTERMEDIATE TRANSFER MEMBER AND METHOD OF MANUFACTURE

(75) Inventors: Dante M. Pietrantoni, Rochester, NY (US); Jin Wu, Pittsford, NY (US); Jonathan H. Herko, Walworth, NY (US); Michael S. Roetker, Webster, NY (US); Scott J. Griffin, Fairport, NY (US); Francisco J. Lopez, Rochester, NY (US)

(73) Assignee: XEROX CORPORATION, Norwalk, CT (US)

(21) Appl. No.: 12/635,110

(22) Filed: Dec. 10, 2009

(51) Int. Cl. C08G 73/10; H01B 1/24; H01B 1/12; C08L 33/24; B05D 5/12; B32B 5/00

(52) U.S. Cl. 428/220; 528/322; 252/500; 252/511; 525/411; 427/58; 427/122

(57) ABSTRACT

There is described herein an intermediate transfer member including a polyimide polymer having the formula:

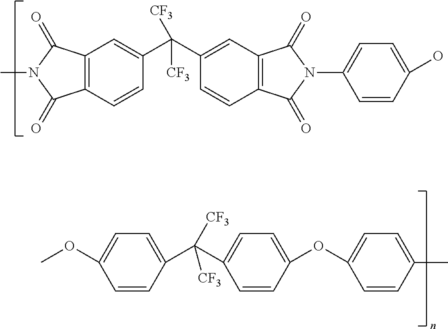

wherein n is from about 50 to about 2,000.

### BACKGROUND

1. Field of Use

This disclosure is directed to an image forming apparatus and an intermediate transfer member.

2. Background

Image forming apparatuses in which a color or black and white image is formed by using an intermediate transfer member to electrostatically transfer toner are well known. When an image is formed on a sheet of paper in a color image forming apparatus using such an intermediate transfer member, four color images in yellow, magenta, cyan and black respectively are generally first transferred sequentially from an image carrier such as a photoreceptor and superimposed on the intermediate transfer member (the primary transfer). This full color image is then transferred to a sheet of paper in a single step (the secondary transfer). In a black and white image-forming apparatus, a black image is transferred from the photoreceptor and superimposed on an intermediate transfer member, and then transferred to a sheet of paper.

An intermediate transfer member is required in an image-forming apparatus.

### SUMMARY

According one embodiment, an intermediate transfer member including a polyimide polymer having the formula:

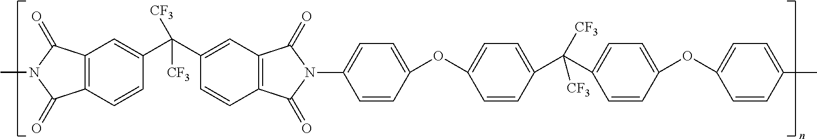

wherein n is from about 50 to about 2,000, is disclosed.

According another embodiment, an intermediate transfer member having a fluorinated polyimide polymer having a cure temperature of less that 200° C., a glass transition temperature of from about 160° C. to about 360° C., a water contact angle of from about 70° to about 120° is disclosed. Carbon black is present in the intermediate transfer member at from about 5 to about 20 weight percent.

Another embodiment described herein is a method of manufacturing an intermediate transfer member. The method includes dissolving a polyimide having a formula:

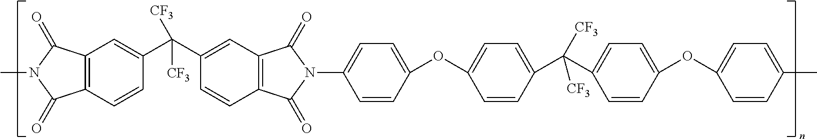

wherein n is from about 50 to about 2,000, in a solvent selected from the group consisting of tetrahydrofuran (THF), methyl ethyl ketone (MEK), methyl isobutyl ketone (MIBK), N,N′-dimethylformamide (DMF), N,N′-dimethylacetamide (DMAc), N-methylpyrrolidone (NMP), methylene chloride and the like and mixtures thereof. The solution of the dissolved second polyimide polymer is milled with a conductive additive to form a dispersion. The dispersion is coated on a substrate. The dispersion is then cured.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a schematic illustration of an image apparatus.

FIG. 2 is a schematic representation of an embodiment disclosed herein.

It should be noted that some details of the figures have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

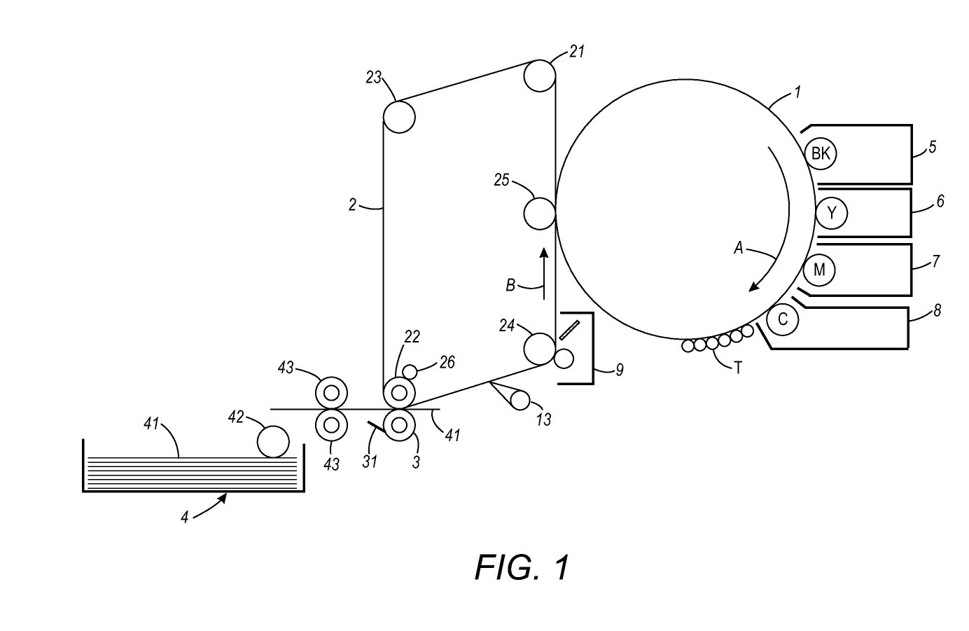

Referring to FIG. 1, an image forming apparatus includes an intermediate transfer member as described in more detail below. The image forming apparatus is an intermediate transfer system comprising a first transfer unit for transferring the toner image formed on the image carrier onto the intermediate transfer member by primary transfer, and a second transfer unit for transferring the toner image transferred on the intermediate transfer member onto the transfer material by secondary transfer. Also in the image forming apparatus, the intermediate transfer member may be provided as a transfer-conveying member in the transfer region for transferring the toner image onto the transfer material. Having an intermediate transfer member that transfers images of high quality and remains stable for a long period is required.

The image forming apparatus described herein is not particularly limited as far as it is an image forming apparatus of intermediate transfer type, and examples include an ordinary monochromatic image forming apparatus accommodating only a monochromatic color in the developing device, a color image forming apparatus for repeating primary transfer of the toner image carried on the image carrier sequentially on the intermediate transfer member, and a tandem color image forming apparatus having plural image carriers with developing units of each color disposed in series on the intermediate transfer member. More specifically, it may arbitrarily comprise an image carrier, a charging unit for uniformly charging the surface of the image carrier, an exposure unit for exposing the surface of the intermediate transfer member and forming an electrostatic latent image, a developing unit for developing the latent image formed on the surface of the image carrier by using a developing solution and forming a toner image, a fixing unit for fixing the toner unit on the transfer material, a cleaning unit for removing toner and foreign matter sticking to the image carrier, a destaticizing unit for removing the electrostatic latent image left over on the surface of the image carrier, and others by known methods as required.

As the image carrier, a known one may be used. As its photosensitive layer, an organic system, amorphous silicon, or other known material may be used. In the case of the image carrier of cylindrical type, it is obtained by a known method of molding aluminum or aluminum alloy by extrusion and processing the surface. A belt form image carrier may also used.

The charging unit is not particularly limited and known chargers may be used, such as a contact type charger using conductive or semiconductive roller, brush, film and rubber blade, scorotron charger or corotron charge making use of corona discharge, and others. Above all, the contact type charging unit is preferred from the viewpoint of excellent charge compensation capability. The charging unit usually applies DC current to the electrophotographic photosensitive material, but AC current may be further superposed.

The exposure unit is not particularly limited and, for example, an optical system device, which exposes a desired image on the surface of the electrophotographic photosensitive material by using a light source such as semiconductor laser beam, LED beam, liquid crystal shutter beam or the like, or through a polygonal mirror from such light source may be used.

The developing unit may be properly selected depending on the purpose, and, for example, a known developing unit for developing by using one-pack type developing solution or two-pack type developing solution, with or without contact, using brush and roller may be used.

The first transfer unit includes known transfer chargers such as a contact type transfer charger using member, roller, film and rubber blade, and scorotron transfer charger or corotron transfer charger making use of corona discharge. Above all, the contact type transfer charger provides excellent transfer charge compensation capability. Aside from the transfer charger, a peeling type charger may be also used together.

The second transfer unit may be the same as the first transfer unit, such as a contact type transfer charger using transfer roller and others, scorotron transfer charger, and corotron transfer charger. By pressing firmly by the transfer roller of the contact type transfer charger, the image transfer stage can be maintained. Further, by pressing the transfer roller or the contact type transfer charger at the position of the roller for guiding the intermediate transfer member, the action of moving the toner image from the intermediate transfer member to the transfer material may be done.

As the photo destaticizing unit, for example, a tungsten lamp or LED may be used, and the light quality used in the photo destaticizing process may include white light of tungsten lamp and red light of LED. As the irradiation light intensity in the photo destaticizing process, usually the output is set to be about several times to 30 times of the quantity of light showing the half exposure sensitivity of the electrophotographic photosensitive material.

The fixing unit is not particularly limited, and any known fixing unit may be used, such as heat roller fixing unit and oven fixing unit.

The cleaning unit is not particularly limited, and any known cleaning device may be used.

A color image forming apparatus for repeating primary transfer is shown schematically in FIG. 1. The image forming apparatus shown in FIG. 1 includes a photosensitive drum 1 as image carrier, an intermediate transfer member 2, shown as an intermediate transfer belt, a bias roller 3 as transfer electrode, a tray 4 for feeding paper as transfer material, a developing device 5 by BK (black) toner, a developing device 6 by Y (yellow) toner, a developing device 7 by M (magenta) toner, a developing device 8 by C (cyan) toner, a member cleaner 9, a peeling pawl 13, rollers 21, 23 and 24, a backup roller 22, a conductive roller 25, an electrode roller 26, a cleaning blade 31, a block of paper 41, a pickup roller 42, and a feed roller 43.

In the image forming apparatus shown in FIG. 1, the photosensitive drum 1 rotates in the direction of arrow A, and the surface of the charging device (not shown) is uniformly charged. On the charged photosensitive drum 1, an electrostatic latent image of a first color (for example, BK) is formed by an image writing device such as a laser writing device. This electrostatic latent image is developed by toner by the developing device 5, and a visible toner image T is formed. The toner image T is brought to the primary transfer unit comprising the conductive roller 25 by rotation of the photosensitive drum 1, and an electric field of reverse polarity is applied to the toner image T from the conductive roller 25. The toner image T is electrostatically adsorbed on the intermediate transfer member 2, and the primary transfer is executed by rotation of the intermediate transfer member 2 in the direction of arrow B.

Similarly, a toner image of a second color, a toner image of a third color, and a toner image of a fourth color are sequentially formed and overlaid on the transfer belt 2, and a multi-layer toner image is formed.

The multi-layer toner image transferred on the transfer belt 2 is brought to the secondary transfer unit comprising the bias roller 3 by rotation of the transfer belt 2. The secondary transfer unit comprises the bias roller 3 disposed at the surface side carrying the toner image of the transfer belt 2, backup roller 22 disposed to face the bias roller from the back side of the transfer belt 2, and electrode roller 26 rotating in tight contact with the backup roller 22.

The paper 41 is taken out one by one from the paper block accommodated in the paper tray 4 by means of the pickup roller 42, and is fed into the space between the transfer belt 2 and bias roller 3 of the secondary transfer unit by means of the feed roller 43 at a specified timing. The fed paper 41 is conveyed under pressure between the bias roller 3 and backup roller 22, and the toner image carried on the transfer belt 2 is transferred thereon by rotation of the transfer member 2.

The paper 41 on which the toner image is transferred is peeled off from the transfer member 2 by operating the peeling pawl 13 at the retreat position until the end of primary transfer of the final toner image, and conveyed to the fixing device (not shown). The toner image is fixed by pressing and heating, and a permanent image is formed. After transfer of the multi-layer toner image onto the paper 41, the transfer member 2 is cleaned by the cleaner 9 disposed at the downstream side of the secondary transfer unit to remove the residual toner, and is ready for next transfer. The bias roller 3 is provided so that the cleaning blade 31, made of polyurethane or the like, may be always in contact, and toner particles, paper dust and other foreign matter sticking by transfer are removed.

In the case of transfer of a monochromatic image, the toner image T after primary transfer is immediately sent to the secondary transfer process, and is conveyed to the fixing device. But in the case of transfer of multi-color image by combination of plural colors, the rotation of the intermediate transfer member 2 and photosensitive drum 1 is synchronized so that the toner images of plural colors may coincide exactly in the primary transfer unit, and deviation of toner images of colors is prevented. In the secondary transfer unit, by applying a voltage of the same polarity (transfer voltage) as the polarity of the toner to the electrode roller 26 tightly contacting with the backup roller 22 disposed oppositely through the bias roller 3 and intermediate transfer member 2, the toner image is transferred onto the paper 41 by electrostatic repulsion. Thus, the image is formed.

The intermediate transfer member 2 can be of any suitable configuration. Examples of suitable configurations include a sheet, a film, a web, a foil, a strip, a coil, a cylinder, a drum, an endless mobius strip, a circular disc, a drelt (a cross between and drum and a belt), a belt including an endless belt, an endless seamed flexible belt, an endless seamless flexible imaging belt, an endless belt having a puzzle cut seam, and the like. In FIG. 1, the transfer member 2 is depicted as a belt.

In an image on image transfer, the color toner images are first deposited on the photoreceptor and all the color toner images are then transferred simultaneously to the intermediate transfer member. In a tandem transfer, the toner image is transferred one color at a time from the photoreceptor to the same area of the intermediate transfer member. Both embodiments are included herein.

Transfer of the developed image from the photoconductive member to the intermediate transfer member and transfer of the image from the intermediate transfer member to the substrate can be by any suitable technique conventionally used in electrophotography, such as corona transfer, pressure transfer, bias transfer, and combinations of those transfer means, and the like.

The intermediate transfer member has been a high temperature cure polyimide having a suitable high elastic modulus and the polyimide capable of becoming conductive upon the addition of electrically conductive particles. A polyimide having a high elastic modulus optimizes the film stretch registration and transfer or transfix conformance.

The intermediate transfer member can be of any suitable configuration. Examples of suitable configurations include a sheet, a film, a web, a foil, a strip, a coil, a cylinder, a drum, an endless strip, a circular disc, a belt including an endless belt, an endless seamed flexible belt, and an endless seamed flexible belt.

Conventional polyimide intermediate transfer members need a high temperature cure such as over about 300° C. or about 370° C. This leads to high manufacturing costs. A low temperature cure or low core polyimide is desirable for low manufacturing cost if it retains similar properties to the high cure polyimide.

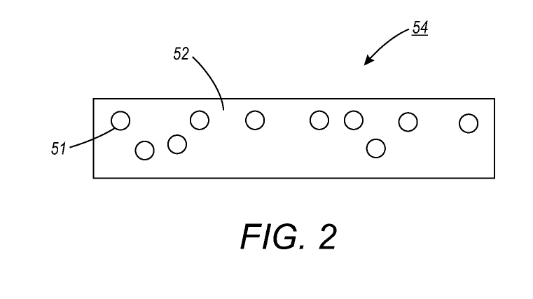

In an embodiment shown in FIG. 2, the intermediate transfer member 54 is in the form of a film in a one layer configuration. An intermediate transfer member 54 includes a single layer of a low temperature cure polyimide. The single layer further contains conductive filler particles 51.

Low temperature cure polyimides include those having cure temperatures of equal to or less than about 200° C., or from about 60° C. to about 180° C., or from about 80° C. to about 120° C.

In embodiments, the low temperature cure polyimide has a glass transition temperature of from about 160° C. to about 360° C., or from about 200° C. to about 300° C. In addition, the low temperature cure polyimide has a water contact angle of from about 70° to about 120°, or from about 85° to about 110°.

An example of a low-temperature cure polyimide includes one having the following chemical structure:

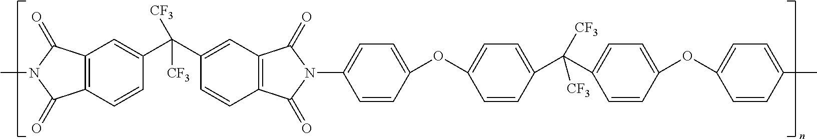

Wherein n is from about 50 to about 2000, or from about 100 to 1000, or from about 200 to about 800.

Commercial examples of a low temperature cure polyimide include LaRC™-CP1, which possesses excellent attributes for intermediate transfer member application such as high glass transition temperature (T_{g}) of about 263° C., and low coefficient of thermal expansion of about 51.2 ppm/° C., and LaRC™-CP2, which possesses excellent attributes for intermediate transfer member application such as high glass transition temperature (T_{g}) of about 209° C., and low coefficient of thermal expansion of about 47 ppm/° C., both available from ManTech SRS Technologies, Huntsville, Ala.

The electrically conductive particles 51 dispersed in the low cure polyimide outer layer 52 decrease the resistivity into the desired surface resistivity range of from about 10⁹ ohms/square, to about 10¹³ ohms/square, or from about 10¹⁰ ohms/square, to about 10¹² ohms/square. The volume resistivity is from about 10⁸ ohm-cm to about 10¹² ohm-cm, or from about 10⁹ ohm-cm to about 10¹¹ ohm-cm. The resistivity can be provided by varying the concentration of the conductive filler.

Examples of conductive fillers include carbon blacks such as carbon black, graphite, acetylene black, fluorinated carbon black, and the like; metal oxides and doped metal oxides, such as tin oxide, antimony dioxide, antimony-doped tin oxide, titanium dioxide, indium oxide, zinc oxide, indium oxide, indium-doped tin trioxide, and the like; and mixtures thereof, and polyaniline. The conductive filler may be present in an amount of from about 1 to about 60 and or from about 3 to about 40, or from about 5 to about 20 weight percent of total solids of the intermediate transfer member.

Carbon black surface groups can be formed by oxidation with an acid or with ozone, and where there is absorbed or chemisorbed oxygen groups from, for example, carboxylates, phenols, and the like. The carbon surface is essentially inert to most organic reaction chemistry except primarily for oxidative processes and free radical reactions.

The conductivity of carbon black is dependent on surface area and its structure primarily. Generally, the higher the surface area and the higher the structure, the more conductive is the carbon black. Surface area is measured by the B.E.T. nitrogen surface area per unit weight of carbon black, and is the measurement of the primary particle size. The surface area of the carbon black described herein is from about 460 m²/g to about 35 m²/g. Structure is a complex property that refers to the morphology of the primary aggregates of carbon black. It is a measure of both the number of primary particles comprising primary aggregates, and the manner in which they are “fused” together. High structure carbon blacks are characterized by aggregates comprised of many primary particles with considerable “branching” and “chaining”, while low structure carbon blacks are characterized by compact aggregates comprised of fewer primary particles. Structure is measured by dibutyl phthalate (DBP) absorption by the voids within carbon blacks. The higher the structure, the more the voids, and the higher the DBP absorption.

Examples of carbon blacks selected as the conductive component for the ITM include VULCAN® carbon blacks, REGAL® carbon blacks, MONARCH® carbon blacks and BLACK PEARLS® carbon blacks available from Cabot Corporation. Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); Channel carbon blacks available from Evonik-Degussa; Special Black 4 (B.E.T. surface area=180 m²/g, DBP absorption=1.8 ml/g, primary particle diameter=25 nanometers), Special Black 5 (B.E.T. surface area=240 m²/g, DBP absorption=1.41 ml/g, primary particle diameter=20 nanometers), Color Black FW1 (B.E.T. surface area=320 m²/g, DBP absorption=2.89 ml/g, primary particle diameter=13 nanometers), Color Black FW2 (B.E.T. surface area=460 m²/g, DBP absorption=4.82 ml/g, primary particle diameter=13 nanometers), and Color Black FW200 (B.E.T. surface area=460 m²/g, DBP absorption=4.6 ml/g, primary particle diameter=13 nanometers).

Further examples of conductive fillers include doped metal oxides. Doped metal oxides include antimony doped tin oxide, aluminum doped zinc oxide, antimony doped titanium dioxide, similar doped metal oxides, and mixtures thereof.

Suitable antimony doped tin oxides include those antimony doped tin oxides coated on an inert core particle (e.g., ZELEC®ECP-S, M and T) and those antimony doped tin oxides without a core particle (e.g., ZELEC®ECP-3005-XC and ZELEC®ECP-3010-XC, ZELEC® is a trademark of DuPont Chemicals Jackson Laboratories, Deepwater, N.J.). The core particle may be mica, TiO₂ or acicular particles having a hollow or a solid core.

The intermediate transfer member may include a second polyimide polymer including a polyimide, a polyamideimide or a polyetherimide and the like and mixtures thereof, present in an amount of from about 1 to about 95, or from about 10 to about 60 parts by weight of total solids of the intermediate transfer member.

Polyimide examples are inclusive of rapidly cured polyimide polymers, such as VTEC™ PI 1388, 080-051, 851, 302, 203, 201, and PETI-5, all available from Richard Blaine International, Incorporated, Reading, Pa. These thermosetting polyimides can be cured at temperatures of from about 180 to about 260° C. over a short period of time, such as from about 10 to about 120 minutes, or from about 20 to about 60 minutes; possess a number average molecular weight of from about 5,000 to about 500,000, or from about 10,000 to about 100,000, and a weight average molecular weight of from about 50,000 to about 5,000,000, or from about 100,000 to about 1,000,000. Also, other thermosetting polyimides that can be cured at temperatures of above 300° C. include PYRE M.L® RC-5019, RC 5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Examples of polyamideimides that can be used in the intermediate transfer member are VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15, T_{g}=255° C., and M_{w}=8,000), HR-13NX (30 weight percent solution in N-methylpyrrolidone/xylene=67/33, T_{g}=280° C., and M_{w}=10,000), HR-15ET (25 weight percent solution in ethanol/toluene=50/50, T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON® AI-10 (T_{g}=272° C.), commercially available from Solvay Advanced Polymers, LLC, Alpharetta, Ga.

Examples of polyetherimides are ULTEM® 1000 (T_{g}=210° C.), 1010 (T_{g}=217° C.), 1100 (T_{g}=217° C.), 1285, 2100 (T_{g}=217° C.), 2200 (T_{g}=217° C.), 2210 (T_{g}=217° C.), 2212 (T_{g}=217° C.), 2300 (T_{g}=217° C.), 2310 (T_{g}=217° C.), 2312 (T_{g}=217° C.), 2313 (T_{g}=217° C.), 2400 (T_{g}=217° C.), 2410 (T_{g}=217° C.), 3451 (T_{g}=217° C.), 3452 (T_{g}=217° C.), 4000 (T_{g}=217° C.), 4001 (T_{g}=217° C.), 4002 (T_{g}=217° C.), 4211 (T_{g}=217° C.), 8015, 9011 (T_{g}=217° C.), 9075, and 9076, all commercially available from Sabic Innovative Plastics.

Also, polyimides that may be selected as the intermediate transfer member may be prepared as fully imidized polymers which do not contain any “amic” acid, and do not require high temperature cure to convert them to the imide form. A typical polyimide of this type may be prepared by reacting di-(2,3-dicarboxyphenyl)-ether dianhydride with 5-amino-1-(p-aminophenyl)-1,3,3-trimethylindane. This polymer is available as Polyimide XU 218 sold by Ciba-Geigy Corporation, Ardsley, N.Y. Other fully imidized polyimides are available from Lenzing Corporation in Dallas, Tex., and are sold as Lenzing P83 polyimide and by Mitsui Toatsu Chemicals, New York, N.Y. sold as Larc-TPI.

Examples of specific selected thermoplastic polyimide are KAPTON® KJ, commercially available from E.I. DuPont, Wilmington, Del., as represented by

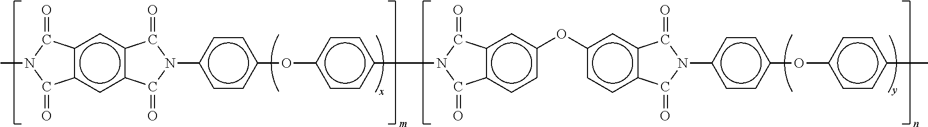

wherein x is equal to 2; y is equal to 2; m and n are from about 10 to about 300; and IMIDEX®, commercially available from West Lake Plastic Company, as represented by

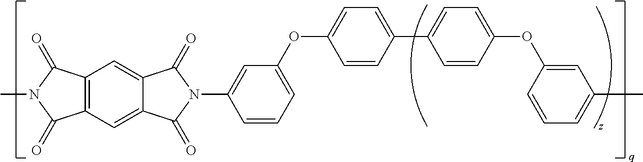

wherein z is equal to 1, and q is from about 10 to about 300.

The thickness of the intermediate transfer member is from about 30 microns to about 400 microns, or from about 50 microns to about 200 microns, or from about 70 microns to about 150 microns.

A method of manufacturing the intermediate transfer member includes dissolving a polyimide having a formula:

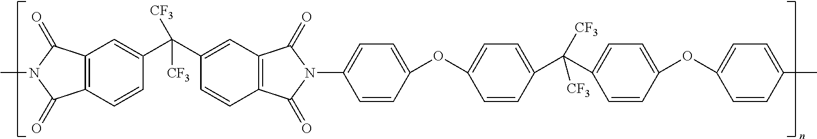

wherein n is from about 50 to about 2,000, in a solvent. The solvent can be any solvent that dissolves the low temperature cure polyimide. Examples include tetrahydrofuran (THF), methyl ethyl ketone (MEK), methyl isobutyl ketone (MIBK), N,N′-dimethylformamide (DMF), N,N′-dimethylacetamide (DMAc), N-methylpyrrolidone (NMP), methylene chloride and the like and mixtures thereof. The solution of the dissolved polyimide is milled with a conductive additive to form a dispersion. The dispersion is coated on a metal substrate such as aluminum, or stainless steel. The dispersion is cured to form a belt or roller.

### Examples

Experimentally, the LaRC™-CP1 polyimide (the number average molecular weight was determined to be about 170,000, the weight average molecular weight was about 480,000, and the glass transition temperature was about 263° C., available from ManTech SRS Technologies, Huntsville, Ala.) was dissolved in THF, and then mixed with varying amounts of carbon black FW-1 (B.E.T. surface area of 320 m²/g, DBP absorption of 2.89 ml/g, primary particle diameter of 13 nanometers, from Evonik) with a solid content about 20 weight percent. The mixtures were ball milled to obtain the intermediate transfer belt coating dispersions. The dispersions were coated on an aluminum sheet, and then dried at 80° C. for 20 minutes. Free standing intermediate transfer belt devices were obtained with a thickness of about 50 μm, and the test results are shown in Table 1.

The surface layer itself was tested and the data are shown in Table 1. The first column provides the weight percent of the polyimide/carbon black of the outer layer. The surface resistivity is shown in the second column and the modulus is shown in the third column.

TABLE 1

| | Surface resistivity | Modulus |
|---|---|---|
| | (ohm/sq) | (MPa) |
| LaRC ™-CP1/FW-1 = 90/10 | 7.4 × 10⁵ | 6,300 |
| LaRC ™-CP1/FW-1 = 95/5 | 3.5 × 10⁹ | N.A. |

The above intermediate transfer belt members or devices were measured for surface resistivity (averaging four to six measurements at varying spots, 72° F./65 percent room humidity) using a High Resistivity Meter (Hiresta-Up MCP-HT450 available from Mitsubishi Chemical Corp.). With proper amount of carbon black such as 5 weight percent in the intermediate transfer member, the surface resistivity can be adjusted in the functional range of from about 10⁹ to about 10¹² ohm/square.

The above intermediate transfer belt member or device of LaRC™-CP1/color black FW-1=90/10 was measured for Young's modulus following the ASTM D882-97 process. The sample (0.5 inch×12 inch) was placed in the measurement apparatus, the Instron Tensile Tester, and then elongated at a constant pull rate until breaking. During this time, the instrument recorded the resulting load versus sample elongation. The modulus was calculated by taking any point tangential to the initial linear portion of this curve and dividing the tensile stress by the corresponding strain. The tensile stress was given by load divided by the average cross sectional area of the test specimen.

The modulus of the resulting intermediate transfer member was about 6,300 MPa. This is comparable to or better than that of the high cure polyimide intermediate transfer belts on the market. The low cure intermediate transfer member described herein provides a lower cost manufacturing option.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. An intermediate transfer member comprising:
a polyimide polymer having the formula: 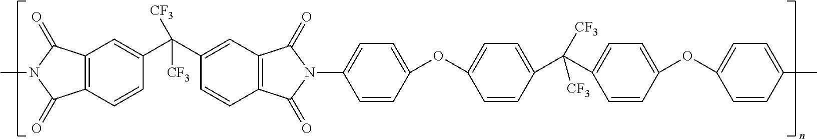
wherein n is from about 50 to about 2,000.

2. The intermediate transfer member of claim 1 wherein n is from about 100 to about 1,000.

3. The intermediate transfer member of claim 1 wherein the polyimide polymer is curable at a temperature equal to or less than about 200° C.

4. The intermediate transfer member of claim 1, further comprising a conductive additive.

5. The intermediate transfer member of claim 4 wherein the conductive additive comprises from about 1 to about 60 weight percent of the intermediate transfer member.

6. The intermediate transfer member of claim 4 wherein the conductive additive comprises carbon black.

7. The intermediate transfer member of claim 6 wherein the carbon black comprises a surface area of from about 460 m²/g to about 35 m²/g.

8. The intermediate transfer member of claim 1, further comprising a second polyimide polymer.

9. The intermediate transfer member of claim 1 wherein polyimide polymer has a glass transition temperature of from about 160° C. to about 360° C.

10. The intermediate transfer member of claim 1 wherein polyimide has a coefficient of thermal expansion of about 51.2 ppm/° C.

11. The intermediate transfer member of claim 1 comprising a surface resistivity of from about 10⁹ ohms/square to about 10¹³ ohms/square.

12. The intermediate transfer member of claim 1 comprising a volume resistivity of from about 10⁸ ohm-cm to about 10¹² ohm-cm.

13. The intermediate transfer member of claim 1 wherein the polyimide polymer has thickness of from about 30 μm to about 400 μm.

14. A method of manufacturing an intermediate transfer member comprising:
dissolving a polyimide having a formula 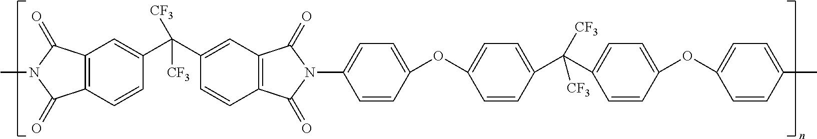
wherein n is from about 50 to about 2,000, in a solvent selected from the group consisting of tetrahydrofuran (THF), methyl ethyl ketone (MEK), methyl isobutyl ketone (MIBK), N,N′-dimethylformamide (DMF), N,N′-dimethylacetamide (DMAc), N-methylpyrrolidone (NMP) and methylene chloride;
milling the dissolved polyimide with a conductive additive to form a dispersion;
coating the dispersion on a substrate; and
curing the dispersion.

15. The method of claim 14 wherein the curing is a temperature of less that 200° C.

16. The method of claim 14 wherein the conductive additive comprises carbon black.

17. The method of claim 16 wherein the carbon black comprises from about 1 to about 60 weight percent of the total solids of the dispersion.

18. The method of claim 16 wherein the carbon black comprises a surface area of from about 460 m²/g to about 35 m²/g.

19. An intermediate transfer member comprising:
a polyimide polymer having a cure temperature of less that 200° C., a glass transition temperature of from about 160° C. to about 360° C., a water contact angle of from about 70° to about 120°; and
carbon black from about 5 to about 20 weight percent of the intermediate transfer member.

20. The intermediate transfer member of claim 19 wherein the polyimide polymer comprises the formula: 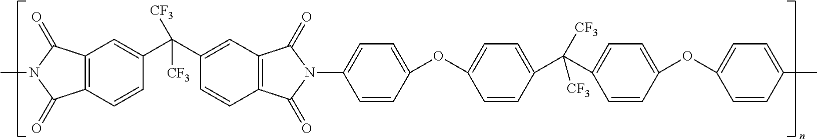
wherein n is from about 200 to about 800.
